(19) United States
(12) Patent Application Publication
(10) Pub. No.: US 2015/0234408 A1
(43) Pub. Date: Aug. 20, 2015

(54) METHOD AND APPARATUS FOR ENERGY MANAGEMENT CONSIDERING MULTIPLE CONTEXT

(71) Applicant: Electronics and Telecommunications Research Institute, Daejeon (KR)

(72) Inventors: Hyun-Jeong LEE, Daejeon (KR); Wan-Ki PARK, Daejeon (KR); Il-Woo LEE, Daejeon (KR)

(21) Appl. No.: 14/618,417

(22) Filed: Feb. 10, 2015

(30) Foreign Application Priority Data
Feb. 17, 2014 (KR) 10-2014-0018023

(51) Int. Cl. G05F 1/66; G05B 15/02

(52) U.S. Cl. CPC G05F 1/66; G05B 15/02

(57) ABSTRACT

The present invention relates to a method and apparatus for energy management considering multiple context. An embodiment of the present invention allows providing an energy management and saving plan, which is generated by collecting information about space, user, device, service profile, user's energy using pattern, user number, sensor data, energy saving information, weather information, regulations relating thereto, real-time energy price information, demand response information, big data and ontology, to manage and save energy efficiently.

### CROSS REFERENCE TO RELATED APPLICATION

This application claims the benefit of Korean Patent Application No. 10-2014-0018023, filed on Feb. 17, 2014, entitled “Method and Apparatus for Energy Management considering Multiple Context”, which is hereby incorporated by reference in its entirety into this application.

### BACKGROUND

1. Technical Field

The present invention relates to a method and apparatus for energy management considering multiple context.

2. Description of the Related Art

A variety of services are being provided to save energy in various areas such as buildings, houses, industries and logistics. Among those services, there is a method to manage and save energy using static context data such as service profiles, energy profiles and the like and dynamic context data such as sensor data, weather data, energy usage and the like.

However, this method considers only a part of various parameters which change dynamically such as user's energy using pattern, user number and the like, so that it causes problems in energy management according to dynamic context and difficulties to respond appropriately to energy price changes, demand responses, regulations and the like.

### SUMMARY

An object of the present invention is to provide a method and apparatus for energy management considering multiple context which is able to save and manage energy efficiently by collecting information about space, user, device, service profile, user's energy using pattern, user number, sensor data, energy saving information, weather information, regulations relating thereto, real-time energy price information, demand response information, big data and ontology, and providing an energy management and saving plan to an energy user.

Another object of the present invention is to provide a method and apparatus for energy management considering multiple context which is able to provide an energy management and saving plan by including additional context information when additional context information such as future new energy-related regulations is also considered.

According to an embodiment of the present invention, there is provided a multiple context-based energy management system comprising: an energy consuming unit; an energy service providing unit providing energy and an energy service profile to the energy consuming unit; an energy information managing unit storing energy information required to manage energy which is consumed from the energy consuming unit; and a multiple context based energy management apparatus receiving static context data and dynamic context data from the energy consuming unit, mapping the static context data and the dynamic context data to the energy service profile to generate energy mapping information, and providing an energy management plan based on the energy mapping information and the energy information.

According to another embodiment of the present invention, there is provided a multiple context based energy management apparatus comprising: an energy context data managing unit receiving static context data and dynamic context data from an energy consuming unit and managing it; an additional context data managing unit managing additional context data inputted from a user; a context information mapping unit mapping the static context data and the dynamic context data to an energy service profile to generate energy mapping information; an energy management plan generating unit generating an energy management plan based on the energy mapping information and energy information; and a communication unit transmitting the energy management plan to the energy consuming unit.

In an embodiment, the energy consuming unit may comprise an energy using module; an energy usage measurement sensor measuring energy usage which is consumed from the energy using module; an energy context data generation module generating the static context data and the dynamic context data corresponding to the energy usage; and an energy using module controlling unit controlling the energy using module based on the energy management plan.

In another embodiment, the static context data may comprise at least one selected from a space profile, a user profile, a device profile and a service profile of the energy consuming unit.

In still another embodiment, the dynamic context data may comprise at least one selected from user's energy using pattern, user number, sensor data, weather data, real-time energy price information, demand response information, energy saving-related big data, ontology information and energy-related regulations.

In still another embodiment, the energy saving-related big data may comprise at least one selected from energy-related statistics, energy-saving methods, management methods and regulations.

In still another embodiment, the ontology information may comprise at least one selected from information relating to use of energy, information relating to energy equipment, and information relating to energy services.

In still another embodiment, the additional context data may comprise at least one selected from new regulations applied to the energy consuming unit and data for additional energy-related context.

In still another embodiment, the energy information managing unit may comprise an energy information collecting unit collecting the energy information from at least one selected from web portals, public websites and data storages; and an energy information storing unit storing the energy information.

In still another embodiment, the energy information may comprise at least one selected from energy saving information, weather information, energy-related regulations, real-time energy price information, demand response information, big data and ontology information.

In still another embodiment, the energy management plan generating unit may generate a benchmarking model based on past energy usage statistics, weather data, user's energy using pattern, and user number and generate the energy management plan based on the benchmarking model.

In still another embodiment, the context information mapping unit generates the energy mapping information by providing weighting factor to the static context data and the dynamic context data and mapping them to the energy service profile, wherein the energy management plan generating unit generates an energy management plan based on the weighting factor-provided energy mapping information and the energy information.

According to another embodiment of the present invention, there is provided a multiple context-based energy management method comprising: receiving static context data and dynamic context data from an energy consuming unit; receiving an energy service profile from an energy service providing unit; receiving energy information from an energy information managing unit; generating energy mapping information by mapping the static context data and the dynamic context data to the energy service profile; generating an energy management plan based on the energy mapping information and the energy information; and transmitting the energy management plan to the energy consuming unit.

In an embodiment, the step for generating an energy management plan based on the energy mapping information and the energy information may comprise generating a benchmarking model based on past energy usage statistics, weather data, user's energy using pattern, and user number and generating the energy management plan based on the benchmarking model.

In another embodiment, the method may further comprise determining if there is additional context data inputted from a user; and generating the energy mapping information by including the additional context data if there is.

The method and apparatus for energy management considering multiple context according to an embodiment of the present invention allows saving and managing energy efficiently by collecting information about space, user, device, service profile, user's energy using pattern, user number, sensor data, energy saving information, weather information, regulations relating thereto, real-time energy price information, demand response information, big data and ontology and providing an energy management and saving plan to an energy user.

The method and apparatus for energy management considering multiple context according to another embodiment of the present invention allows providing an energy management and saving plan by including additional context information when additional context information such as future new energy-related regulations is also considered.

### BRIEF DESCRIPTION OF THE DRAWINGS

FIG. 1 illustrates a multiple context-based energy management system according to an embodiment of the present invention.

FIG. 2 illustrates internal configuration of a multiple context based energy management apparatus according to an embodiment of the present invention.

FIG. 3 is a flowchart illustrating a multiple context based energy management method according to an embodiment of the present invention.

### DESCRIPTION OF THE EXEMPLARY EMBODIMENTS

The above and other objects, features and advantages of the present invention will become more apparent to those of ordinary skill in the art by describing in detail exemplary embodiments thereof with reference to the accompanying drawings. Throughout the description of the present invention, when describing a certain technology is determined to evade the point of the present invention, the pertinent detailed description will be omitted. The terms used hereinafter are defined by considering their functions in the present invention and can be changed according to the intention, convention, etc. of the user or operator. While the present invention will be described with reference to particular embodiments, it is to be appreciated that various changes and modifications may be made by those skilled in the art without departing from the spirit and scope of the present invention, as defined by the appended claims and their equivalents. Therefore, the definitions of these terms shall be made based on the overall description of this specification.

Hereinafter, exemplary embodiments of the present invention will be described in detail with reference to the accompanying drawings.

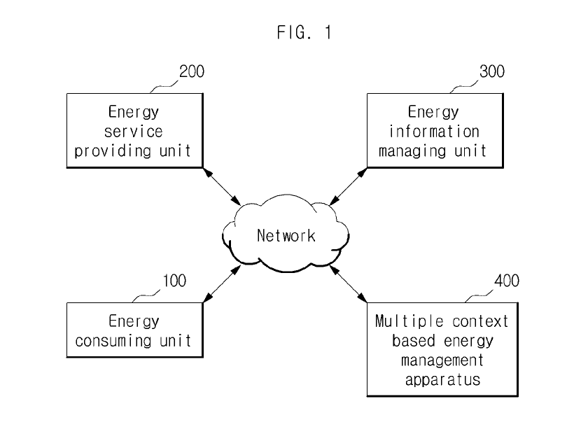

FIG. 1 illustrates a multiple context-based energy management system according to an embodiment of the present invention.

Referring to FIG. 1, a multiple context-based energy management system according to an embodiment of the present invention may comprise an energy consuming unit 100, an energy service providing unit 200, an energy information managing unit 300 and a multiple context based energy management apparatus 400.

The energy consuming unit 100 may be a subject which consumes energy. In an embodiment, the energy consuming unit 100 may be space which consumes energy. For example, the space which consumes energy may be an industrial building or a residential building. The energy consuming unit 100 may include any place or device which consumes energy.

The energy service providing unit 200 may provide energy, energy services and energy service profiles to the energy consuming unit 100. Here, energy may include electric energy, water energy, gas energy, heat-combined energy and the like.

The energy service may include services for managing and saving electric energy, water energy, gas energy, heat-combined energy and the like. The energy service profile may include attributes of an energy provider, an energy service provider, energy price, an energy using method and the like for the energy service.

The energy information managing unit 300 may store information about energy using space, energy using device, energy usage, energy price and the like which are required when the energy consuming unit 100 manages energy.

The multiple context based energy management apparatus 400 may generate energy mapping information by receiving static context data and dynamic context data from the energy consuming unit 100 and mapping the static context data and the dynamic context data to the energy service profile. The multiple context based energy management apparatus 400 may also provide an energy management plan which is generated based on the energy mapping information and the energy information to the energy consuming unit 100.

A multiple context based energy management apparatus 400 and method according to an embodiment of the present invention may provide an energy management and saving plan, which is generated by collecting information about space, user, device, service profile, user's energy using pattern, user number, sensor data, energy saving information, weather information, regulations relating thereto, real-time energy price information, demand response information, big data and ontology, to an energy user so that the energy user is able to manage and save energy efficiently.

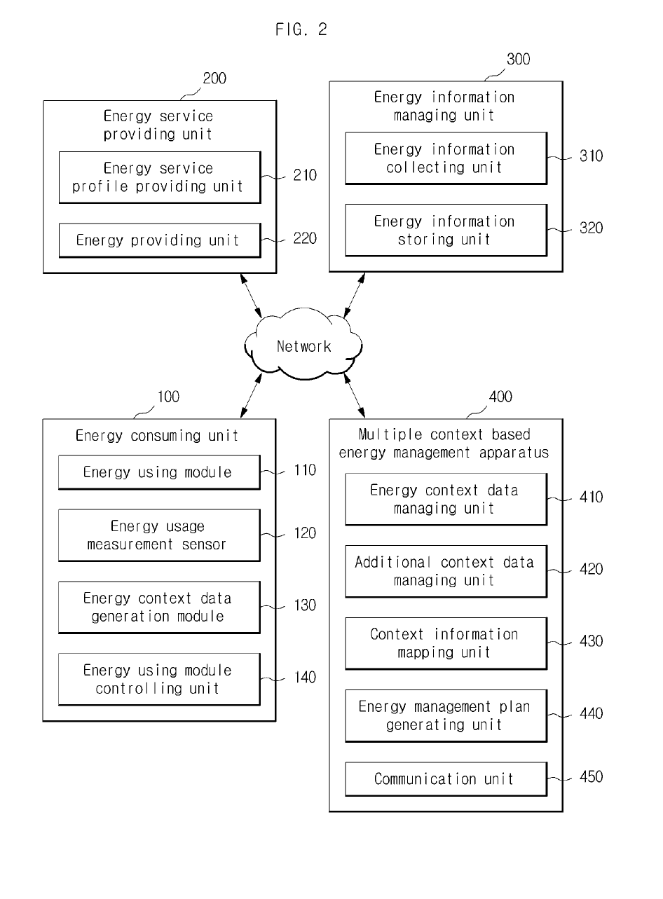

FIG. 2 illustrates internal configuration of a multiple context based energy management apparatus according to an embodiment of the present invention.

Referring to FIG. 2, the multiple context based energy management apparatus 400 may comprise an energy context data managing unit 410, an additional context data managing unit 420, a context information mapping unit 430, an energy management plan generating unit 440 and a communication unit 450.

The energy context data managing unit 410 may receive static context data and dynamic context data from the energy consuming unit 100 and manage them.

In an embodiment, the static context data may include at least one selected from space profile of the energy consuming unit 100, user profile, device profile and service profile. The dynamic context data may include at least one selected from user's energy using pattern of the energy consuming unit 100, user number, sensor data, weather data, real-time energy price information, demand response information, energy saving-related big data, ontology information and energy-related regulations.

For example, the energy saving-related big data may include at least one selected from energy-related statistics, energy-saving method, management method and regulations and the ontology information may include information relating to use of energy, information relating to energy equipments, information relating to energy services.

The additional context data managing unit 420 may manage additional context data inputted from a user. For example, when energy-related regulations applied to the energy consuming unit 100 are revised, the additional context data managing unit 420 may manage additional information of the revised energy-related regulations. The additional context data may include new regulations applied to the energy consuming unit and data for additional energy-related context. The additional context data may be updated according to the user.

The context information mapping unit 430 may generate energy mapping information by mapping static context data and dynamic context data to an energy service profile. When the static context data is a specific space profile and the dynamic context data is the number of people who are recognized in the specific space, the context information mapping unit 430 may generate temperature mapping information of the specific space corresponding to current weather information by searching an energy service profile.

The context information mapping unit 430 may also generate energy mapping information by providing weighting factor to static context data and dynamic context data and mapping the result to an energy service profile. Here, the energy management plan generating unit 440 may generate an energy management plan based on the weighting factor-provided energy mapping information and the energy information.

In case of that the number of people recognized in a specific space is changed, for example, if any remained person is not detected in the specific space, energy mapping information may be generated by mapping temperature which needs to be maintained when there is no person in the specific space through searching the energy service profile.

The energy management plan generating unit 440 may generate an energy management plan on the basis of the energy mapping information and the energy information. When any remained person is not detected in a specific space, temperature in the specific space may be controlled based on energy mapping information which needs to be set at a certain temperature and weather information. For example, in case of that temperature is maintained at 26° when any remained person is detected in a specific space, temperature is maintained at 20° when any remained person is not detected in a specific space, and weather information is 10° below zero, maintaining temperature at 20° consumes energy, so that an energy management plan to maintain temperature at 10° may be generated.

The energy management plan generating unit 440 may also generate an energy management plan based on a benchmarking model which is selected based on past energy usage statistics, weather data, user's energy using pattern, user number and the like.

The communication unit 450 may transmit the energy management plan to the energy consuming unit 100. The multiple context based energy management apparatus 400 may be connected to the energy service providing unit 200, the energy information managing unit 300 and the energy consuming unit 100 via wire or wireless network.

Wire or wireless network may include wireless LAN (WLAN), Wi-Fi, wireless Broadband (Wibro), world interoperability for microwave access (Wimax), high speed downlink packet access (HSDPA), IEEE 802.16, long term cvolution (LTE), wireless mobile broadband service (WMBS) and the like.

Examples of near field communication may include Bluetooth, radio frequency identification9 RFID), infrared data association (IrDA), ultra wideband (UWB), ZigBee, near field communication (NFC) and the like. Examples of wire communication may include USB communication, Ethernet, serial communication, optical/coaxial cable and the like.

The energy consuming unit 100 according to an embodiment of the present invention may comprise an energy using module 110, an energy usage measurement sensor 120, an energy context data generation module 130 and an energy using module controlling unit 140.

The energy using module 110 may include an energy consuming device. In an embodiment, the energy using module 110 may include a lightening device and a heating device.

The energy usage measurement sensor 120 may measure energy usage consumed at the energy using module. For example, the energy usage measurement sensor 120 may be a sensor to measure energy usage consumed by the energy using module 110 or a sensor to measure gas amount provided to the energy using module.

The energy context data generation module 130 may generate static context data and dynamic context data corresponding to the energy usage.

The energy using module controlling unit 140 may control the energy using module 110 based on the energy management plan. The energy management plan may be received from the multiple context based energy management apparatus 400.

The energy service providing unit 200 according to an embodiment of the present invention may comprise an energy service profile providing unit 210 and an energy providing unit 220.

The energy service profile providing unit 210 may include attributes of an energy provider, an energy service provider, energy price, an energy using method and the like for the energy providing service, energy saving service, energy management service and the like and energy such as electric energy, water energy, gas energy, heat-combined energy and the like.

The energy providing unit 220 may provide energy such as electric energy, water energy, gas energy, heat-combined energy and the like.

The energy information managing unit 300 according to an embodiment of the present invention may include an energy information collecting unit 310 and an energy information storing unit 320.

The energy information collecting unit 310 may collect energy information from at least one selected from web portals, public websites and data storages. Here, the energy information may include at least one selected from energy saving information, weather information, energy-related regulations, real-time energy price information, demand response information, big data and ontology information.

The energy information storing unit 320 may store the energy information. In an embodiment, the energy information storing unit 320 may be at least one type of a flash memory type, a hard disk type, a multimedia card micro type, a card type memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk.

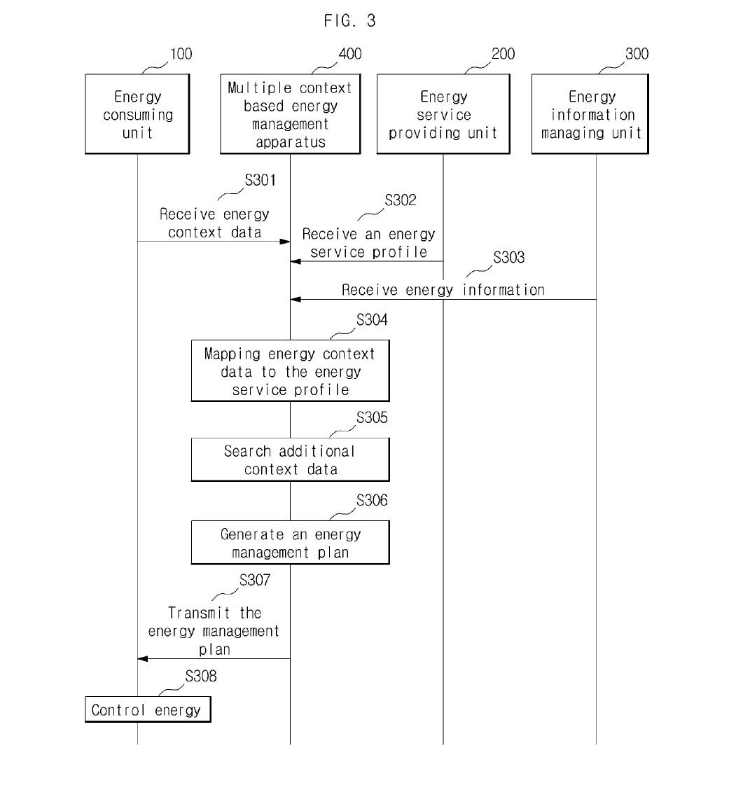

FIG. 3 is a flowchart illustrating a multiple context based energy management method according to an embodiment of the present invention.

Referring to FIG. 3, in S301, the multiple context based energy management apparatus 400 may receive energy context data from the energy consuming unit 100.

The energy context data may include static context data and dynamic context data. For example, the static context data may include a space profile, a user profile, a device profile and a service profile of the energy consuming unit 100. The dynamic context data may include user's energy using pattern of the energy consuming unit 100, user number, sensor data, weather data, real-time energy price information, demand response information, energy saving-related big data, ontology information and energy-related regulations.

The multiple context based energy management apparatus 400 may generate an energy-saving method for the energy consumed by the energy consuming unit 100 using the energy context data.

In S302, the multiple context based energy management apparatus 400 may receive an energy service profile from the energy service providing unit 200. Here, the energy service profile may include an energy management method and an energy energy-saving method.

In S303, the multiple context based energy management apparatus 400 may receive energy information from the energy information managing unit 300. The energy information managing unit 300 may collect the energy information from web portals, public websites and data storages and store the collected information. Here, the energy information may include energy saving information, weather information, energy-related regulations, real-time energy price information, demand response information, big data and ontology information.

In S304, the multiple context based energy management apparatus 400 may generate energy mapping information by mapping energy context data to the energy service profile. For example, when any person is not present in a specific space, a service profile controlling a lightening device may be configured as shown in the following Table 1.

```
TABLE 1
- <EndDeviceControl href=“/drp/1/edc” replyTo=“{hostname}/rsp”
responseRequired=“01” subscribable=“0” xmlns=“http://zigbee.org/sep”>
  <mRID>RoomLight</mRID>
  <description>Light Energy Saving Service</description>
  <creationTime>1234556</creationTime>
- <EventStatus>
  <currentStatus>1</currentStatus>
  <dateTime>20131230</dateTime>
  <reason>Person Exist</reason>
  </EventStatus>
- <ServiceLight>
  <Existence>0</Existence> //if people do not exist
<duration>10</duration> //minute
<controlLight>off</controlLight>
  </ServiceLight>
```

In S305, it may be searched if there is additional context data. The additional context data may include new regulations applied to the energy consuming unit and data for additional energy-related context and may be inputted in real-time according to a user's request. Furthermore, when there is additional context data, energy mapping information including the additional context data may be generated.

In S306, an energy management plan may be generated. The multiple context based energy management apparatus 400 may generate the energy management plan on the basis of the energy mapping information obtained in S303 and the energy information obtained in S304. In an embodiment, generating the energy management plan based on the energy mapping information and the energy information may include generating an energy management plan based on a benchmarking model which is selected on the basis of past energy usage statistics, weather data, user's energy using pattern, and user number.

In S307, the multiple context based energy management apparatus 400 may transmit the energy management plan to the energy consuming unit 100.

In S308, the energy consuming unit 100 may control energy suitable for the context based on the energy management plan.

The method or algorithm steps described with reference to exemplary embodiments of the present invention can be implemented by using hardware, software executing in processors or its combination. The software module can be installed in a RAM memory, a flash memory, a ROM memory, an EPROM memory, an EEPROM memory, a resistor, a hard disk, a detachable disk, a CD-ROM, or any type of storage medium well-known in the art. An exemplary storage medium can be combined with the processor, so that the processor can read information from the storage medium and write information to the storage medium. Alternatively, the storage medium can be integrated to the processor. The processor and the storage medium can be installed in ASIC. The ASIC can be located in a user's terminal. The processor and the storage medium can be also installed as separate components in a user's terminal.

All processors described above can be implemented in software code modules executed by more than one general purpose or special purpose computers or processors and can be fully automated through the software code modules. The code modules can be stored in a computer readable medium or another computer storage device or an integrated device of storage devices. All or a part of the methods can be implemented in specialized computer hardware.

All methods and tasks described herein can be executed by a computer system and be fully automated. The computer system can include multicomputer or computing devices (e.g., servers, workstations, storage arrays and the like) communicating through network and interacting one another to perform the described functions. Each computing device usually includes program languages stored in a memory or another non-transitory computer readable storage medium or processors (or multi-processors or circuits or integrated form of circuits such as module) executing modules. All or a part of functions described herein can be implemented to application-specific circuits (e.g., ASICs or FPGAs) of the computer system and also implemented to program languages. When the computer system includes several computing devices, the devices can be arranged at the same place even though it is not necessary. The methods and tasks' results described herein can be stored permanently in different forms by physical storage devices such as solid state memory chips and/or magnetic disks.

The exemplary embodiments of the present invention described hereinabove are only an example of the present invention and may be variously modified and altered by those skilled in the art to which the present invention pertains without departing from essential features of the present invention.

What is claimed is:

1. A multiple context-based energy management system comprising:
an energy consuming unit;
an energy service providing unit configured to provide energy and an energy service profile to the energy consuming unit;
an energy information managing unit configured to store energy information required to manage energy which is consumed from the energy consuming unit; and
a multiple context based energy management apparatus configured to receive static context data and dynamic context data from the energy consuming unit, map the static context data and the dynamic context data to the energy service profile to generate energy mapping information, and provide an energy management plan based on the energy mapping information and the energy information.

2. A multiple context based energy management apparatus comprising:
an energy context data managing unit configured to receive static context data and dynamic context data from an energy consuming unit and manage it;
an additional context data managing unit configured to manage additional context data inputted from a user;
a context information mapping unit configured to map the static context data and the dynamic context data to an energy service profile to generate energy mapping information;
an energy management plan generating unit configured to generate an energy management plan based on the energy mapping information and energy information; and
a communication unit configured to transmit the energy management plan to the energy consuming unit.

3. The multiple context based energy management apparatus of claim 2, wherein the energy consuming unit comprises:
an energy using module;
an energy usage measurement sensor configured to measure energy usage which is consumed from the energy using module;
an energy context data generation module configured to generate the static context data and the dynamic context data corresponding to the energy usage; and
an energy using module controlling unit configured to control the energy using module based on the energy management plan.

4. The multiple context based energy management apparatus of claim 2, wherein the static context data comprises at least one selected from a space profile, a user profile, a device profile and a service profile of the energy consuming unit.

5. The multiple context based energy management apparatus of claim 2, wherein the dynamic context data comprises at least one selected from user's energy using pattern, user number, sensor data, weather data, real-time energy price information, demand response information, energy saving-related big data, ontology information and energy-related regulations.

6. The multiple context based energy management apparatus of claim 5, wherein the energy saving-related big data comprises at least one selected from energy-related statistics, energy-saving methods, management methods and regulations.

7. The multiple context based energy management apparatus of claim 5, wherein the ontology information comprises at least one selected from information relating to use of energy, information relating to energy equipment, and information relating to energy services.

8. The multiple context based energy management apparatus of claim 2, wherein the additional context data comprises at least one selected from new regulations applied to the energy consuming unit and data for additional energy-related context.

9. The multiple context based energy management apparatus of claim 2, wherein the energy information managing unit comprises an energy information collecting unit configured to collect the energy information from at least one selected from web portals, public websites and data storages; and an energy information storing unit configured to store the energy information.

10. The multiple context based energy management apparatus of claim 2, wherein the energy information comprises at least one selected from energy saving information, weather information, energy-related regulations, real-time energy price information, demand response information, big data and ontology information.

11. The multiple context based energy management apparatus of claim 2, wherein the energy management plan generating unit generates a benchmarking model based on past energy usage statistics, weather data, user's energy using pattern and user number, and generate the energy management plan based on the benchmarking model.

12. The multiple context based energy management apparatus of claim 2, wherein the context information mapping unit generates the energy mapping information by providing weighting factor to the static context data and the dynamic context data and mapping them to the energy service profile,
wherein the energy management plan generating unit generates an energy management plan based on the weighting factor-provided energy mapping information and the energy information.

13. A multiple context-based energy management method comprising:
receiving static context data and dynamic context data from an energy consuming unit;
receiving an energy service profile from an energy service providing unit;
receiving energy information from an energy information managing unit;
generating energy mapping information by mapping the static context data and the dynamic context data to the energy service profile;
generating an energy management plan based on the energy mapping information and the energy information; and
transmitting the energy management plan to the energy consuming unit.

14. The multiple context-based energy management method of claim 13, wherein the generating an energy management plan based on the energy mapping information and the energy information comprises generating a benchmarking model based on past energy usage statistics, weather data, user's energy using pattern and user number, and generating the energy management plan based on the benchmarking model.

15. The multiple context-based energy management method of claim 13, further comprising determining if there is additional context data inputted from a user; and generating the energy mapping information by including the additional context data if there is.
